(19) United States
(12) Patent Application Publication
(10) Pub. No.: US 2020/0196399 A1
(43) Pub. Date: Jun. 18, 2020

(54) METHOD FOR OPERATING AN INDUCTION HOB

(71) Applicant: E.G.O. Elektro-Geraetebau GmbH, Oberderdingen (DE)

(72) Inventors: Christian Egenter, Bretten (DE); Marcus Frank, Sulzfeld (DE); Etienne Fuchs, St. Leon-Rot (DE); Stephane Lomp, Oberderdingen (DE)

(21) Appl. No.: 16/703,948

(22) Filed: Dec. 5, 2019

(30) Foreign Application Priority Data
Dec. 12, 2018 (DE) 10 2018 221 521.9

(51) Int. Cl. H05B 6/06; H05B 6/12

(52) U.S. Cl. CPC H05B 6/065; H05B 2213/06; H05B 6/1209

(57) ABSTRACT

In order to detect whether a cooking vessel with an integrated controller or intelligence is arranged over an induction heating coil on an induction hob, the induction heating coils emit a short individual coding. This can be detected and evaluated by the cooking vessel, with the result that the cooking vessel emits a signal which corresponds to this coding and is received by an external operating device or the induction hob for the purpose of locally assigning this cooking vessel to this induction heating coil.

### CROSS-REFERENCE TO RELATED APPLICATIONS

This application claims priority to German Application No. 10 2018 221 521.9, filed Dec. 12, 2018, the contents of which are hereby incorporated herein in its entirety by reference.

### FIELD OF APPLICATION AND PRIOR ART

The invention relates to a method for operating an induction hob, in particular with specially designed cooking vessels.

DE 102004016631 A1 discloses an arrangement which can be used to detect when a cooking vessel is placed on a heating device or a heating area and its position on a heating device or a heating area in the case of a hob. In this case, a plurality of capacitively acting sensors are provided in the outer area of a heating device.

### OBJECT AND SOLUTION

The invention is based on the object of providing a method mentioned at the outset and an induction hob designed to carry out said method, with which problems in the prior art can be eliminated and it is possible, in particular, to be able to reliably detect both when a cooking vessel is placed onto or into a heating area and an identity of the cooking vessel and to display this to an operator, if necessary.

This object is achieved by means of a method having the features of claim 1 and by means of an induction hob having the features of claim 31. Advantageous and preferred configurations of the invention are the subject matter of the further claims and are explained in more detail below. In this case, some of the features are described and explained only for the method or only for the induction hob. However, irrespective of this, they are intended to be able to apply both to the method and to the induction hob autonomously and independently of one another. The wording of the claims is incorporated in the content of the description by express reference.

For the method for operating an induction hob having a plurality of induction heating coils, provision is made for each induction heating coil to have a heating area. The latter is formed substantially by the surface above it corresponding to the size of the induction heating coil. A cooking vessel can be arranged on the induction hob in such a manner that it covers at least one heating area, advantageously only a single heating area of one induction heating coil. Each induction heating coil is designed to transmit or to transfer energy for heating a cooking vessel in the heating area, in which case it is controlled in a known manner by a converter. Each cooking vessel has a transmitting apparatus with a transmitting antenna for transmitting a signal which depends on received energy or on the type of transferred energy from an induction heating coil, the heating area of which is at least partially covered by the cooking vessel. This cooking vessel advantageously largely or completely covers the heating area.

A receiving device is provided for the purpose of receiving signals from a transmitting apparatus of a cooking vessel or from all transmitting apparatuses of cooking vessels on the induction hob. This receiving device can be provided on the induction hob and can be alternatively or additionally provided on external operating device or a mobile terminal.

A controller is provided, which controller receives the signals from the receiving device and has or receives the information relating to transmission or transfer of energy from the induction heating coils. In a similar manner to the receiving device, this controller can be provided on the induction hob and can be alternatively or additionally provided on an external operating device or a mobile terminal. The receiving device and the controller are preferably arranged together or in the same device.

The method has the following steps:

At least one cooking vessel is arranged over a heating area of an induction heating coil, advantageously precisely one cooking vessel for precisely one detection operation. This can be carried out with the induction hob switched off or on and can likewise be carried out in the case of an induction hob which is already being operated or is providing heat. A multiplicity of the induction heating coils, in particular all of the induction heating coils, are controlled to transmit or transfer energy in a pattern, wherein the duration and/or amplitude is/are varied as coding. The coding involves varying the amplitude of the transmitted or transferred energy within the coding over time, in particular between zero and a coding maximum value, and/or varying the duration of the energy transfer, and/or varying the duration between two energy transfer operations, and/or varying the number of energy transfer operations. These possibilities can be used individually or in combination, in which case this also depends on the number of required codings or the induction heating coils to be checked.

If a cooking vessel covers a heating area of an induction heating coil which has transferred energy with a specific or individual coding, the transmitting apparatus of the cooking vessel transmits a signal or a sequence of a plurality of signals, which uniquely depend on this received coding and/or can be assigned to precisely this received coding, to the receiving device. The controller receives the signals received by the receiving device and compares said signals with information relating to the energy transmitted or transferred by the induction heating coils as codings which are known to the controller. The controller can thus determine which coding of transferred energy from a particular induction heating coil matches a received signal or a sequence of a plurality of signals, wherein the signal has been received at the same time or shortly afterward. On the basis thereof, the controller can assign the cooking vessel transmitting this signal or this sequence of a plurality of signals to the heating area or to the induction heating coil associated with the heating area since it is clear that the cooking vessel can have received the coding determining the signal only from the induction heating coil arranged underneath it. The controller can therefore determine that this cooking vessel covers the heating area of this induction heating coil. Alternatively, in the invention, the determination of the transmitting induction heating coil or the determination of the assignment of the cooking vessel to the induction heating coil can also fundamentally take place in the cooking vessel itself, for example in an integrated circuit or a microcontroller of the cooking vessel. An item of information relating to this is then advantageously transmitted to said controller.

This induction heating coil can then be controlled precisely for heating this cooking vessel, for example using a cooking program which is also known per se. In an advantageous configuration, sensors can be arranged on the cooking vessel for the purpose of monitoring a cooking process in the cooking vessel and their data can then be accurately assigned.

In an advantageous configuration of the invention, a cooking vessel has a receiving coil in order to store an alternating magnetic field of an induction heating coil, which is used to transfer energy, as electrical energy or to convert it into electrical energy. The signal can then be emitted by means of the transmitting antenna of the transmitting apparatus. The energy required for this purpose can be advantageously the previously received or stored energy.

An energy storage can be provided in the cooking vessel and is connected to the receiving coil, wherein the energy received by the receiving coil is stored in the energy storage, as described above. A signal or a sequence of a plurality of signals can then be emitted by the transmitting apparatus with or in accordance with the stored energy. This advantageously corresponds to the received coding or contains the latter or its identification.

The energy received by the receiving coil can be used directly to electrically control the transmitting antenna to transmit a signal or a sequence of a plurality of signals, which may be an alternative to the above-mentioned storage of the energy. In this case, the length and/or strength of the at least one signal, in particular the sequence of a plurality of signals, can correspond to the variance of the duration and/or amplitude of the coding. It is therefore possible to transfer an item of information, for example the number or identifier of that induction heating coil, in the heating area of which the cooking vessel is situated and the coding of which has therefore been received.

In this case, provision may be made for the transmitting antenna to transmit a signal as soon as energy is transferred to the receiving coil by an induction heating coil, the heating area of which is covered by the cooking vessel or has the cooking vessel arranged there. The transmitting apparatus advantageously transmits a signal as long as energy is transferred or transmitted from the induction heating coil to the receiving coil as coding. The transmitting apparatus also does not transmit a signal any more as soon as no more energy is transferred from the induction heating coil to the receiving coil.

In a further configuration, the transmission or transfer of energy in induction heating coils, in the case of which it is not known whether their heating area is covered by a cooking vessel, can be repeated frequently and/or regularly in order to detect cooking vessels arranged in their heating area. This can be carried out, in particular, with a frequency or repetition frequency corresponding to an interval of time of less than 1 minute, preferably less than 5 seconds. The controller is therefore informed very quickly as soon as such a cooking vessel has been arranged in the heating area of an induction heating coil.

Energy from the induction heating coils can be advantageously transmitted or transferred with coding only when a cooking vessel with a transmitting apparatus for detecting a coding reports to the induction hob or when an operator inputs this into a controller of the induction hob.

Provision can be advantageously made for the transmission or transfer of energy from the induction heating coils with coding for detecting cooking vessels arranged in the heating area to be at least also carried out if a change in a coverage of a heating area by a cooking vessel is detected. This means the situation in which the cooking vessel has been shifted, either far away or out of the heating area, or has been shifted only by a few cm. This can also be detected.

In a further configuration of the method, provision may be made for the method to be carried out on a mobile terminal or an external control device with a controller and a receiving device only when an app on the mobile terminal is active or when the external control device is activated. The actual above-mentioned cooking program with the special cooking vessel can then be carried out on this mobile terminal or external control device. If these are not active, the method need not be carried out either. Provision may be made for the detection of when the mobile terminal or the external control device is switched on or coupled to the induction hob to automatically cause the method to be started.

Provision may also be made for the method to be carried out only when a special cooking vessel with the above-mentioned receiving coil and a transmitting apparatus has been discovered on the induction hob or in a heating area. Further so-called pot detection sensors can also be used for this purpose. The cooking vessel preferably also has an integrated circuit and at least one sensor, as explained above. The integrated circuit can evaluate the sensor and can be used to transmit the information with the evaluation of the sensor, that is to say advantageously not only the sensor signal directly and alone, to a controller of the mobile terminal or of the external control device or to a controller of the induction hob.

A coding preferably consists of a very short power output, referred to as “pings” below, or pulses which oscillate at an operating frequency or the resonant frequency of a resonant circuit containing the induction heating coil. A ping or a pulse has one or more oscillations and lasts as long as the oscillations and is therefore formed by the oscillations. A total duration of a ping or pulse is preferably between 1 μsec and 500 μsec, in particular between 20 μsec and 100 μsec, that is to say is considerably shorter and of lower energy than is the case when transferring energy for actual heating. This procedure is known to a person skilled in the art and does not need to be explained any further.

Provision may be advantageously made for an interval between two pings or pulses within a coding to have a duration of a power supply half cycle of the power supply or a multiple thereof, preferably an integer multiple thereof. The frequency of the power supply may be 50 Hz or 60 Hz as a domestic power supply, with the result that the interval can then be 10 msec or somewhat more than 8 msec.

The transmitting apparatus can be selected from the group: Bluetooth, BLE, Zigbee, NFC, WiFi. Further transmitting devices are naturally possible, for example including those having proprietary transfer protocols. Bluetooth and BLE are preferred on account of the widespread use of their protocols, but BLE is particularly preferred on account of the very low energy consumption.

As discussed above, the receiving device and the controller can be arranged outside the induction hob, preferably in an external operating device. This external operating device then has operating elements and at least one display device. It may be a mobile terminal such as a smartphone or a tablet computer, but it may also be a very specific external operating device for this induction hob. New functionalities, which would otherwise be possible only with complicated replacement or conversion, if at all, can therefore possibly be integrated in the induction hob or enabled.

A cooking vessel preferably also has an integrated circuit, virtually as intelligence, in addition to the receiving coil and the transmitting apparatus. A certain amount of intelligence can then also be provided in the transmitting apparatus so that it can accordingly preprocess the signals to be transmitted. At least one sensor, for example a temperature sensor or a pressure sensor, is preferably also provided. A cooking program mentioned can therefore be controlled or can take place in a manner known per se because a state can be captured and taken into account in the cooking vessel itself using the sensor. In addition, an above-mentioned energy storage may be a battery, a rechargeable battery or a capacitor. Alternatively, no energy storage can be provided in the cooking vessel, apart from a capacitor, with the result that only energy for operating an integrated circuit and also the transmitting apparatus can be stored therein.

If all induction heating coils are controlled to transfer energy for the purpose of detecting cooking vessels arranged in the heating area, energy can first of all be transferred for a short time as a ping, in which case there is then a pause, and a multiplicity of different codings can then be generated using a varying number of short sequences of transferring energy and pausing or by waiting for a particular multiple of a waiting time. The multiple of a waiting time can be, in particular, between 5% and 20% or 30% of the duration of the entire coding. Each of the induction heating coils is controlled in this case with a different coding to transmit or transfer energy with this coding, but each induction heating coil is always recurrently controlled with the same coding. This coding can preferably permanently belong to this induction heating coil.

The controller advantageously stores which cooking vessel is arranged in the heating area of which induction heating coil. This is retained at least until something changes or until the controller and/or the induction hob is/are switched off. The controller detects cooking vessels newly arranged in a heating area of an induction heating coil in the same manner.

The controller preferably stores which cooking vessel is moved out of a heating area, which is detected by the controller on the basis of changes in the operating parameters of the resonant circuit containing the induction heating coil, that is to say as it were at least by means of the induction heating coil itself, and also by means of the above-mentioned pot detection sensors under certain circumstances.

In a configuration of the invention, transmission or transfer of a coding stops as long as an induction heating coil, after detecting and assigning a cooking vessel to itself or to its heating area, does not register any change or movement of this cooking vessel in its heating area. This registration is advantageously carried out, as mentioned above, by detecting a change in the operating parameters of the resonant circuit containing the induction heating coil. A coding is preferably transmitted to this induction heating coil or to all induction heating coils again only when a change or movement of the cooking vessel in its/their heating area is registered, which can preferably be registered by an induction heating coil or simply by other sensors.

Provision is preferably made for all induction heating coils to begin to transfer a coding or transmit energy at the same time. As a result, this operation can possibly be better brought into line with the other operation of the induction hob.

Each coding advantageously first of all has a ping or energy is briefly transferred for the purpose of synchronization, which is referred to as a so-called synchronization ping. It is used to synchronize the timing in all cooking vessels and to prepare them, if necessary, for a further ping which is soon to follow or for the coding. Each induction heating coil can and should have a different coding after this synchronization ping so that they can be distinguished from the so that the cooking vessels can transmit different signals corresponding to the respective coding.

Within all codings, provision is advantageously made for at least one further ping to follow the synchronization ping at an interval of time, in which case the number of following pings preferably corresponds to a number of an individual induction heating coil or numbering of the induction heating coils. The interval of time between two pings within a coding is particularly advantageously the same in each case up to the last ping before the next synchronization ping.

Alternatively, within all codings, precisely one further ping follows the synchronization ping at an interval of time which is an integer multiple of a specific defined interval duration. The number of integer multiples of the interval duration of the precisely one further ping can correspond to a numbering of the induction heating coils, with the result that the number of pings is not decisive here, but rather an interval of time between them. It is possible to operate with fewer pings here. A coding may have, for example, three pings in addition to a synchronization ping since the information density is mainly in the temporal sequence.

As yet another alternative, provision may be made for a binary number to be transferred by means of the coding. A binary distinction is made by transmitting a ping or no ping at points of a predefined time pattern in each case, as is known per se from signaling technology. Before transferring the binary number, a ping is preferably first of all transmitted or energy is briefly transferred for the purpose of synchronization or as an above-mentioned synchronization ping. This is again important here in order to be able to better detect the individual pings.

Within all codings, an interval of time between two successive pings can preferably be an integer multiple of an interval duration. The number of integer multiples of the interval duration between two successive pings corresponds to a number or numbering of the induction heating coils, wherein each coding has only two pings or three pings, in particular, each with the specific interval with respect to one another.

In an advantageous configuration of the invention, provision may be made for all codings to have (n+1) pings with (two to n) different interval durations. It is therefore possible to distinguish n induction heating coils. In this case, the interval durations can then be evaluated with respect to their combination, which makes it possible to accurately detect the induction heating coil which transmitted this coding.

Provision is advantageously made, in principle, for the transmitting apparatus to transmit an item of already processed information as a signal; in particular, this is directly the number of the induction heating coil which has been evaluated from the coding received from an induction heating coil. An evaluation is advantageously carried out in the transmitting apparatus or in an integrated circuit of the cooking vessel which is in turn formed in or together with the transmitting apparatus in a particularly advantageous manner. In the above-mentioned case of a transmitting apparatus with Bluetooth or BLE or Zigbee, an integrated circuit must be provided anyway. Alternatively, the coding can be evaluated in the receiving device or in the controller.

Provision is preferably made for the method to be carried out only on induction heating coils, the heating area of which is actually covered by a cooking vessel. Other induction heating coils can dispense with this method and can transmit or transfer only individual pings which are needed anyway to detect the presence of cooking vessels and are also conventional, even without a cooking vessel with a receiving coil. The method can also be carried out only on those induction heating coils, the heating area of which is covered only precisely by one cooking vessel.

In the case of so-called flat-surface hobs, it is possible for a cooking vessel to cover the heating area of a plurality of induction heating coils. As a result, this cooking vessel receives the ping patterns of all induction heating coils, the heating areas of which are covered by said cooking vessel. The cooking vessel must therefore possibly detect and extract a plurality of ping patterns of individual induction heating coils from a superimposition of different ping patterns, which is possible. After detecting such a situation, the detecting induction heating coils can also transmit their codings once in succession as a special case.

The hob controller of a flat-surface hob is normally able to determine which induction heating coil is covered by which cooking vessel. Therefore, in the case of a cooking vessel which covers a plurality of induction heating coils, the method can preferably be carried out in each case only on one induction heating coil, preferably only on the induction heating coil which is most covered.

Furthermore, it may be possible that an induction heating coil is covered by a plurality of cooking vessels. Provision is preferably made for the method to be carried out only on those induction heating coils, the heating area of which is covered only by one cooking vessel. If a plurality of cooking vessels are determined, the problem may arise that it is not possible to assign a coding to only precisely one single cooking vessel since two cooking vessels arranged in the heating area receive the same coding.

These and other features emerge not only from the claims but also from the description and the drawings, in which case the individual features may be realized in each case individually or in multiples in the form of sub-combinations in an embodiment of the invention and in other fields, and may constitute advantageous and independently protectable embodiments, for which protection is claimed here. The division of the application into individual sections and sub-headings does not restrict the statements made under these in terms of their general applicability.

### BRIEF DESCRIPTION OF THE DRAWINGS

Further advantages and aspects of the invention emerge from the claims and from the following description of preferred exemplary embodiments of the invention which are explained below on the basis of the figures, in which:

FIG. 1 shows a schematic illustration of an induction hob according to the invention in an arrangement having a cooking vessel placed on a heating area of an induction heating coil together with an external operating device,

FIG. 2 shows a simplified illustration of the functionalities of the cooking vessel with intelligence,

FIGS. 3 to 8 show different codings.

### DETAILED DESCRIPTION OF THE EXEMPLARY EMBODIMENTS

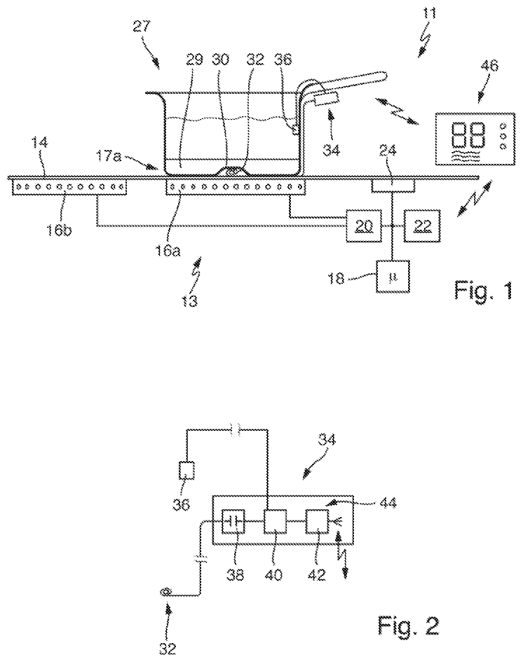

FIG. 1 illustrates an arrangement 11 having an induction hob 13 according to the invention. The induction hob 13 has a hob panel 14, under which two induction heating coils 16a and 16b are arranged. In practice, there are advantageously more induction heating coils 16, for example four or six up to twenty or thirty in the above-mentioned flat-surface hobs.

The induction hob 13 also has a hob controller 18 which is connected to functional units of a converter apparatus 20, a transmitting/receiving device 22 and an operating module 24 on the underside of the hob panel 14. These functional units are each designed in a conventional manner. A radio standard for the transmitting/receiving device 22 can fundamentally be of various designs, as explained at the outset. It is advantageously from the above-mentioned possibilities of Bluetooth or BLE, but also Zigbee, WLAN or the like, as well as proprietary solutions without a universal standard.

Above the heating induction coils 16a and 16b, a heating area is respectively formed with an area which corresponds approximately to the area of the induction heating coils 16 in each case. A cooking vessel 27 is arranged in the heating area 17a or is placed onto the upper side of the hob panel 14 there. The cooking vessel 27 has a receiving coil 32 in a recess 30 in a base 29. The receiving coil 32 has a few turns and is arranged on the underside of the base 29 in such a manner that it is exposed and is not shielded from the magnetic field of the induction heating coil 16a by the rest of the base. This is important for the energy transfer described above. The receiving coil 32 is connected to a cooking vessel module 34 which is illustrated in an enlarged form in FIG. 2.

On the right, FIG. 1 illustrates an external operating device 46 which may be, on the one hand, a special operating device for the induction hob 13 or alternatively a mobile terminal such as a tablet computer or a smartphone. The external operating device 46 has a large-area display, as illustrated. It also has, as is known in particular for the mobile terminals mentioned, a receiving device, a transmitting device and a processor or an integrated circuit. A radio standard here matches the transmitting/receiving device 22, that is to say advantageously Bluetooth or BLE. Not much needs to be said with respect to the external operating device 46; a cooking program explained at the outset can run on it, for example by means of an app or a special program. The external operating unit illustrated is not absolutely necessary. Its function can likewise be integrated in an operating and control unit which is inside the hob.

FIG. 2 illustrates the cooking vessel module 34 in an enlarged form. The cooking vessel module 34 is connected to the receiving coil 32 by means of an electrical connection in the form of a cable or the like. In a similar manner, the cooking vessel module 34 is connected, in an electrically conductive manner, to a temperature sensor 36 which is arranged outside the cooking vessel module and is advantageously arranged inside the cooking vessel 27 according to FIG. 1, with the result that it is surrounded by water or food to be cooked situated there in and can determine the temperature thereof. This temperature sensor can likewise be embedded in the base of the cooking vessel if the base temperature is intended to be captured, rather than the temperature of the food to be cooked. Instead of the temperature sensor 36, yet further sensors such as pressure sensors, weight sensors or the like are alternatively or additionally conceivable.

The cooking vessel module 34 also has an energy storage 38 which is directly connected to the receiving coil 32. This may be a rechargeable battery and is advantageously an above-mentioned capacitor since it need not store particularly large amounts of energy, in particular if transmission is carried out using Bluetooth or BLE or Zigbee, but should do this as quickly and as loss-free as possible.

An integrated circuit 40 as a type of controller is provided in the cooking vessel module 34 and captures precisely energy or the signals or pings received by the receiving coil 32, advantageously with respect to the duration and/or interval and/or amplitude and totaled energy stored in the energy storage 38. The integrated circuit 40 controls a transmitting apparatus 42 with a transmitting antenna 44, advantageously constructed with the above-mentioned Bluetooth or BLE standard or Zigbee.

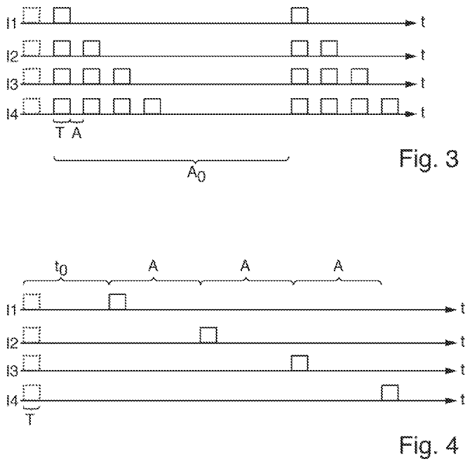

FIG. 3 illustrates a first example of a coding for four induction heating coils I1 to I4, by way of example. First of all, a synchronization ping illustrated using dotted lines can be simultaneously generated for all four induction heating coils, but this need not be the case. Such a synchronization ping and the further pings or pulses are advantageously generated in the manner mentioned at the outset from an operating frequency or resonant frequency of the resonant circuit in which the respective induction heating coil is situated. The duration thereof can be in the above-mentioned range.

After a short time, a first ping having a specific level for the duration T is generated at all four induction heating coils. In the induction heating coil I1, the next individual ping with the same form is then only generated again after the interval of time A₀.

In the second induction heating coil I2, a second ping with the same form is generated shortly after the first ping, namely at the interval of time A. A spell then elapses, namely (A₀-T-A), until a first ping is generated again simultaneously with the first induction heating coil I1 and a second ping is then generated after a short interval of time A.

The pattern of the codings now continues in a similar manner for the third induction heating coil I3 and for the fourth induction heating coil I4, wherein three pings are generated in quick succession and four pings are generated in quick succession, each with the same interval A with respect to one another. The number of the induction heating coils emitting this coding can be directly read by counting these pings, possibly after the synchronization ping. This information can then be identified by the integrated circuit 40 and, in cooperation with the transmitting apparatus 42, can be transmitted as information to the external operating device 46. This transmitted information can then already be, for example, the evaluated number, that is to say “1” or “I1” or the like.

In the pattern of codings according to FIG. 4, a first ping is generated with a duration T at all four induction heating coils I1 to I4 at the same time. After a time to after the first ping, a second ping is generated at the first induction heating coil I1. At an interval of time A later, the second ping is generated at the second induction heating coil I2 and, again at an interval of time A with respect to this, the second ping is generated at the third induction heating coil I3, etc. In this case, the interval of time to can correspond to the interval of time A, with the result that the number of the induction heating coil can be read out by counting these intervals of time until the coding pattern starts again.

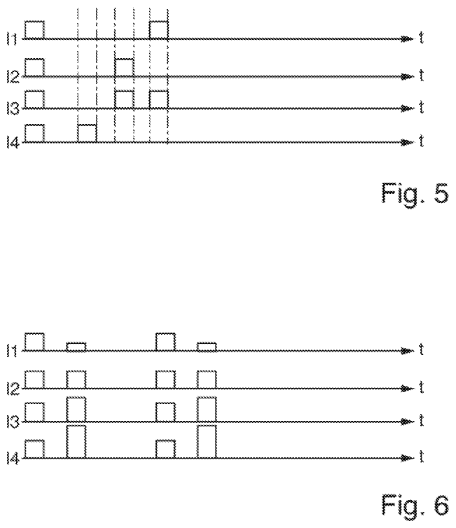

FIG. 5 illustrates, for four induction heating coils I1 to I4, how a binary coding is transmitted as a statement regarding the respective induction heating coil after a first synchronization ping and a short interval of time. In this case, the first induction heating coil I1 transmits a “1” as binary code. The second induction heating coil I2 transmits a “2” as binary code etc.; each induction heating coil therefore transmits its own numeral or number as binary code. By arranging the respective pings in order in the grid illustrated using dotted lines for the binary code, this can be easily achieved and can be fundamentally carried out for a very large number of induction heating coils. Another code can also be used here instead of a binary code.

FIG. 6 illustrates a possible way of making a distinction in the case of four induction heating coils I1 to I4, in each case after a synchronization ping transmitted at the same time for all induction heating coils, using an amplitude of a subsequently transmitted ping. In this case, the amplitude gradually increases with the higher number of the induction heating coil. The pings of different amplitude are transmitted here at the same time, but they can naturally also be transmitted with a time delay.

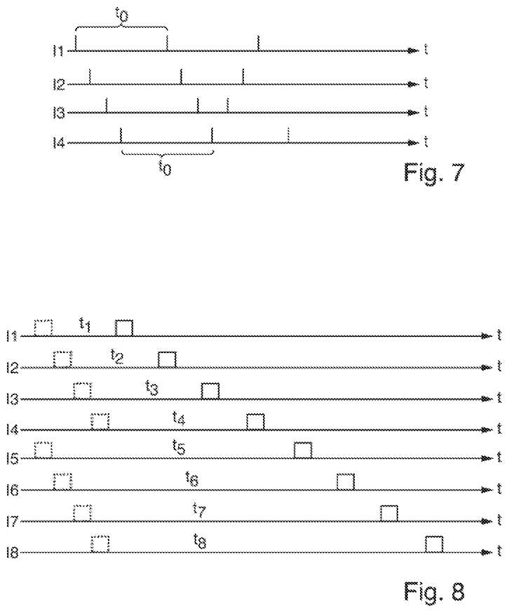

FIG. 7 illustrates how very short pings can be used for four induction heating coils I1 to I4. In order to distinguish the individual induction heating coils by means of three transmitted pings, the interval between the second ping and the third ping is respectively varied. This can be easily seen from FIG. 7.

FIG. 8 illustrates, for eight induction heating coils I1 to I8, how, for two groups of induction heating coils, namely I1 to I4, on the one hand, and I5 to I8, on the other hand, a first ping is respectively transmitted at the same time using two induction heating coils. The interval of time to the subsequent, second ping, which varies from t1 to t8, reveals the number of the induction heating coil transmitting this coding.

On the basis of the transmitted coding of the respective induction heating coil, the number of the induction heating coil, above which the cooking vessel 27 is situated and the coding of which can be received in the heating area, can be communicated in the cooking vessel 27 to the external operating device 46, possibly likewise to the hob controller 18 as well. Precisely this cooking vessel 27 can then be reliably assigned to precisely this heating area of this induction heating coil, which is very important. Since the cooking vessel 27 also has the further sensors, an exactly running cooking program or the like can be carried out in a known manner.

1. A method for operating an induction hob having a plurality of induction heating coils, wherein:
each said induction heating coil has a heating area,
a cooking vessel can be arranged in a manner covering at least one said heating area,
each said induction heating coil is designed to transfer energy for heating one said cooking vessel and is controlled by a converter for this purpose,
each said cooking vessel has a transmitting apparatus with a transmitting antenna for transmitting a signal on a basis of received energy from one said induction heating coil, said heating area of said induction heating coil being at least partially covered by said cooking vessel,
a receiving device is provided for a purpose of receiving signals from a transmitting apparatus of one said cooking vessel or from all said transmitting apparatuses of said cooking vessels on said induction hob,
a controller is provided for receiving said signals from said receiving device and has or receives said information relating to transfer of energy from said induction heating coils,
wherein the method has the following steps:
at least one said cooking vessel is arranged over one said heating area of one said induction heating coil,
a multiplicity of said induction heating coils are controlled to transfer energy in a pattern, wherein a duration and/or an amplitude are varied as coding, wherein said coding involves
varying said amplitude of said transferred energy within said coding over time, in particular between zero and a coding maximum value, and/or
varying said duration of said energy transfer, and/or
varying said duration between two energy transfer operations, and/or
varying a number of said energy transfer operations,
if one said cooking vessel covers one said heating area of said induction heating coil which has transferred energy with a particular coding, said transmitting apparatus transmits a signal or a sequence of a plurality of signals, which uniquely depend on said coding and/or can be assigned to precisely said coding, to said receiving device,
said controller receives said signals received by said receiving device and compares said signals with information relating to said energy transferred by said induction heating coils as codings in order to determine which coding of said transferred energy from one said particular induction heating coil matches a received signal or a sequence of a plurality of signals in order, on the basis thereof, to assign said cooking vessel transmitting said signal or said sequence of a plurality of signals to said heating area or to said induction heating coil associated said the heating area.

2. The method as claimed in claim 1, wherein one said cooking vessel has a receiving coil in order to store an alternating magnetic field of one said induction heating coil, which is used to transfer energy, as electrical energy in order to emit said signal by means of said transmitting antenna of said transmitting apparatus.

3. The method as claimed in claim 1, wherein an energy storage is provided in said cooking vessel and is connected to said receiving coil, wherein energy received by said receiving coil is stored in said energy storage, and wherein a signal or a sequence of a plurality of signals is emitted by said transmitting apparatus in accordance with said stored energy.

4. The method as claimed in claim 1, wherein energy received by said receiving coil is used directly to electrically control said transmitting antenna to transmit a signal or a sequence of a plurality of signals, wherein said length and/or strength of said at least one signal correspond(s) to a variance of said duration and/or amplitude of said coding.

5. The method as claimed in claim 4, wherein said transmitting antenna transmits a signal as soon as energy is transferred to said receiving coil by an induction heating coil, said heating area of which is covered by said cooking vessel, wherein said transmitting apparatus transmits a signal as long as energy is transferred from said induction heating coil to said receiving coil, and wherein said transmitting apparatus does not transmit a signal as soon as no more energy is transferred from said induction heating coil to said receiving coil.

6. The method as claimed in claim 1, wherein said transfer of energy in induction heating coils, in the case of which it is not known that or whether their heating area is covered by one said cooking vessel, is repeated frequently and/or regularly with a frequency or repetition frequency of less than 1 minute in order to detect one said cooking vessel arranged in said heating area.

7. The method as claimed in claim 1, wherein said transfer of energy from said induction heating coils for detecting cooking vessels arranged in said heating area is at least also carried out if a change in a coverage of one said heating area by one said cooking vessel is detected.

8. The method as claimed in claim 1, wherein said method is carried out on a mobile terminal or an external control device with a controller and a receiving device only when an app on said mobile terminal is active or when said external control device is activated.

9. The method as claimed in claim 2, wherein said method is carried out only when on said cooking vessel with one said receiving coil and on said transmitting apparatus has been discovered on said induction hob, wherein said cooking vessel also has an integrated circuit and at least one sensor.

10. The method as claimed in claim 1, wherein one said coding consists of pings or pulses which oscillate at an operating frequency or a resonant frequency of a resonant circuit comprising said induction heating coil, wherein a ping or a pulse has one or more oscillations with a total duration of between 1 μsec and 500 μsec.

11. The method as claimed in claim 10, wherein an interval between two said pings or said pulses within one said coding has a duration of a power supply half cycle of the power supply at 50 Hz or 60 Hz or a multiple thereof.

12. The method as claimed in claim 1, wherein said receiving device and said controller are arranged outside said induction hob in an external operating device, wherein said external operating device has operating elements and at least one display device.

13. The method as claimed in claim 1, wherein one said cooking vessel also has an integrated circuit in addition to said receiving coil and said transmitting apparatus.

14. The method as claimed in claim 13, wherein one said cooking vessel has at least one sensor, such as a temperature sensor or a pressure sensor, and an energy storage.

15. The method as claimed in claim 1, wherein, if all said induction heating coils are controlled to transfer energy for a purpose of detecting one said cooking vessel arranged in said heating area, energy is first of all transferred for a short time as a ping, there is then a pause, and a multiplicity of different codings are then generated using a varying number of short sequences of transferring energy and pausing or by waiting for a particular multiple of a waiting time, and each of said induction heating coils is controlled with a different coding, but each said of induction heating coils is always recurrently controlled with the same coding, for a purpose of transferring energy with said coding.

16. The method as claimed in claim 1, wherein said controller stores which of said cooking vessels is arranged in said heating area of which induction heating coil, wherein said controller detects cooking vessels newly arranged in one said heating area of one said induction heating coil in the same manner.

17. The method as claimed in claim 1, wherein said controller stores which of said cooking vessels is moved out of said heating area, which is detected by said controller on a basis of changes in operating parameters of said resonant circuit comprising said induction heating coil.

18. The method as claimed in claim 1, wherein transmission or transfer of one said coding stops as long as one said induction heating coil, after detecting and assigning one said cooking vessel, does not register any change or movement of said cooking vessel in its heating area by virtue of a change in operating parameters of a resonant circuit comprising said induction heating coil, wherein one said coding is transmitted to said induction heating coil or to all of said induction heating coils again only when a change or movement of said cooking vessel in their heating area is registered.

19. The method as claimed in claim 1, wherein all said induction heating coils begin to transmit a coding at the same time as transmitting energy.

20. The method as claimed in claim 1, wherein each said coding first of all has a ping or energy is briefly transferred for a purpose of synchronization, and each said induction heating coil has a different coding after said synchronization ping.

21. The method as claimed in claim 20, wherein, within all said codings, at least one further ping follows said synchronization ping at an interval of time, and a number of following pings corresponds to a numbering of said induction heating coils, wherein an interval of time within a coding is the same in each case up to the last ping before said next synchronization ping.

22. The method as claimed in claim 20, wherein, within all said codings, precisely one further ping follows said synchronization ping at an interval of time which is an integer multiple of an interval duration, wherein a number of said integer multiples of said interval duration of said precisely one further ping corresponds to a numbering of said induction heating coils.

23. The method as claimed in claim 19, wherein a binary number is transferred by means of said coding, wherein said binary distinction is made by transmitting a ping or no ping at points of a predefined time pattern in each case, wherein, before transferring said binary number, a ping is first of all transmitted or energy is briefly transferred for a purpose of synchronization or as one said synchronization ping as claimed in claim 19.

24. The method as claimed in claim 1, wherein, within all said codings, an interval of time between two successive pings is an integer multiple of an interval duration, wherein a number of said integer multiples of said interval duration between two successive pings corresponds to a numbering of said induction heating coils.

25. The method as claimed in claim 24, wherein all said codings have (n+1) said pings with (two to n) said different interval durations, wherein said interval durations are evaluated with respect to their combination.

26. The method as claimed in claim 1, wherein said transmitting apparatus transmits an item of processed information which has been evaluated from said coding received from one said induction heating coil.

27. The method as claimed in claim 1, wherein said coding is evaluated in said receiving device.

28. The method as claimed in claim 1, wherein said coding is evaluated in said controller.

29. The method as claimed in claim 1, wherein said method is carried out only on those induction heating coils, said heating area of which is assigned only to precisely one said cooking vessel.

30. An induction hob for carrying out the method as claimed in claim 1, wherein:
said induction hob has a plurality of said induction heating coils,
each of said induction heating coils has a heating area,
each of said induction heating coil said is designed to transfer energy for heating one said cooking vessel and is controlled by a converter for this purpose,
each of said cooking vessels has a transmitting apparatus with a transmitting antenna for transmitting a signal on a basis of received energy from one said induction heating coil, said heating area of which is at least partially covered by said cooking vessel,
a receiving device is provided for a purpose of receiving signals from a transmitting apparatus of one said cooking vessel or from all said transmitting apparatuses of said cooking vessels on said induction hob,
said induction hob has a controller which receives said signals from said receiving device and has or receives said information relating to transfer of energy from said induction heating coils.
